(19) United States
(12) Patent Application Publication
(10) Pub. No.: US 2010/0163369 A1
(43) Pub. Date: Jul. 1, 2010

(54) METHOD OF AND APPARATUS FOR BRICK DELIVERY

(76) Inventors: Randy Douglas Woodie, (US); Angelo Solon Mergelos, (US); Paul Samuel Walters, JR., Huntersville, NC (US); William Lewis Russell, JR., Matthews, NC (US)

Correspondence Address: WINSTEAD PC, P.O. BOX 50784, DALLAS, TX, 75201, US

(21) Appl. No.: 12/548,078

(22) Filed: Aug. 26, 2009

Related U.S. Application Data
(60) Provisional application No. 61/091,983, filed on Aug. 26, 2008.

(51) Int. Cl. B65G 37/00; B65G 49/00; B65G 11/20; B65G 15/00; B65G 41/00; B65G 43/08

(52) U.S. Cl. 198/525

(57) ABSTRACT

A material-delivery apparatus includes a conveyor assembly operable to transport material and a lift operable to change an elevation of the conveyor assembly. The conveyor assembly includes a chute comprising a entry point and an exit point and having a limit switch associated with the chute exit point and a conveyor-belt assembly comprising an entry point and an exit point and operable to transport the material from the conveyor-belt assembly entry point to the chute entry point and having a limit switch associated with the conveyor-belt assembly exit point. The conveyor-belt-assembly limit switch and the chute limit switch are operable in combination to control a rate at which the material is transported from the conveyor-belt-assembly entry point to the chute exit point.

### CROSS-REFERENCE TO RELATED APPLICATIONS

This patent application claims priority from, and incorporates by reference for any purpose the entire disclosure of, U.S. Provisional Patent Application No. 61/091,983, filed on Aug. 26, 2008.

### BACKGROUND

1. Technical Field

This patent application relates generally to transport of refractory material, and in particular, to a method of and apparatus for transporting the refractory material such as, for example, bricks from a first location to a second location.

2. History of Related Art

Transporting refractory material such as, for example, molded bricks, blocks, stone, tile, terrazzo or marble may involve individuals working with the refractory material to work in stooped positions. A stooped position is often characterized by prolonged periods of forward bending of the back, which is considered an extreme back posture. Prolonged bending of the back during the transportation of the refractory material may result in injury to, for example, back muscles, nerves, discs and ligaments. Continuous work in a stooped position may lead to lower-back muscle strain, ligament sprain, a bulging or herniated disc, and other related back problems.

### SUMMARY OF THE INVENTION

A material-delivery apparatus includes a conveyor assembly operable to transport material and a lift operable to change an elevation of the conveyor assembly. The conveyor assembly includes a chute comprising a entry point and an exit point and having a limit switch associated with the chute exit point and a conveyor-belt assembly comprising an entry point and an exit point and operable to transport the material from the conveyor-belt assembly entry point to the chute entry point and having a limit switch associated with the conveyor-belt assembly exit point. The conveyor-belt-assembly limit switch and the chute limit switch are operable in combination to control a rate at which the material is transported from the conveyor-belt-assembly entry point to the chute exit point.

A method of transporting material. The method includes transporting, via a conveyor-belt assembly, the material from a conveyor-belt-assembly entry point to a chute entry point and transporting, via a chute passage, the material from the chute entry point to a chute exit point. The method further includes controlling, via a conveyor-belt-assembly limit switch and a chute limit switch, a rate at which the material is transported from the conveyor-belt-assembly entry point to the chute exit point.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a side view of a refractory delivery apparatus;

FIG. 2A is a conceptual illustration of a refractory delivery apparatus;

FIG. 2B is a conceptual illustration of a refractory delivery apparatus;

FIG. 3 is a schematic of a control system; and

FIG. 4 is a flow diagram of a refractory material-transport process.

### DETAILED DESCRIPTION OF ILLUSTRATIVE EMBODIMENTS OF THE INVENTION

Various embodiments of the present invention will now be described more fully with reference to the accompanying drawings. The invention may, however, be embodied in many different forms and should not be construed as limited to the embodiments set forth herein; rather, the embodiments are provided so that this disclosure will be thorough and complete, and will fully convey the scope of the invention to those skilled in the art.

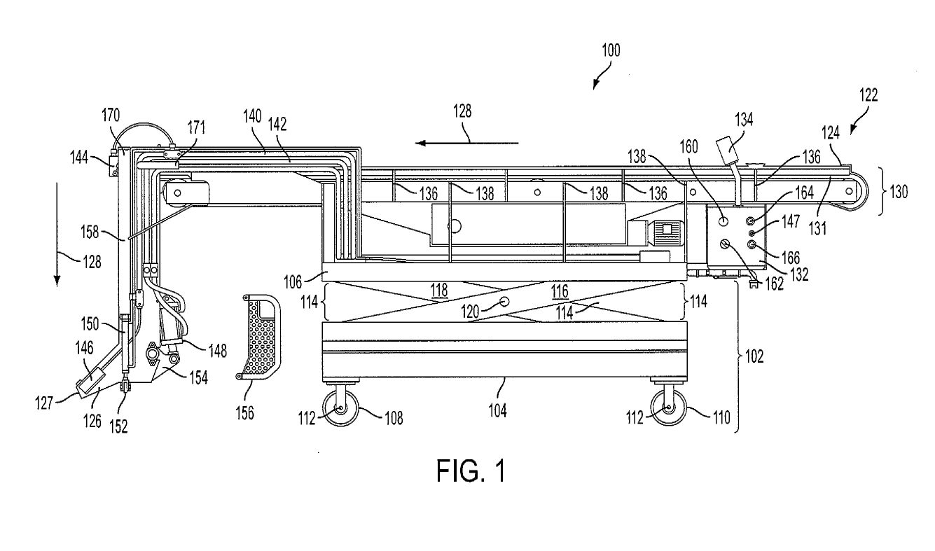

With reference now to the drawings, and in particular to FIGS. 1-4 thereof, a refractory delivery apparatus embodying the principles and concepts of the invention and generally designated by the reference numeral 100 will be described. While the embodiments described herein are identified as an apparatus 100 for delivering refractory material such as, for example, molded bricks, blocks, stone, tile, terrazzo or marble, it will be appreciated by those skilled in the art that the invention is not limited for the delivery of refractory materials, and may be used for the delivery of other materials, such as those used in heavy-metal industries.

Referring now to FIG. 1, a side view of a refractory delivery apparatus 100 will be described in detail. In a typical embodiment, the refractory delivery apparatus 100 includes a lift 102. For exemplary purposes, the lift 102 is illustrated as a scissor lift; however, in other embodiments, other forms of lift for supporting a load at an elevated level may be used. The lift 102 includes a substantially flat base portion 104 and a substantially flat support region 106. The substantially flat base portion 104 includes a plurality of wheels attached thereto (only two wheels 108, 110 being illustrated). In a typical embodiment, the plurality of wheels are rotatably secured to ends of a conventionally secured axle 112. The plurality of wheels facilitate moving the refractory delivery apparatus 100 from one location to another.

The lift 102 further includes a plurality of leg assemblies 114. The plurality of leg assemblies 114 are operable to interconnect the substantially flat base portion 104 and the substantially flat support region 106 to maintain a predetermined relationship between the substantially flat base portion 104 and the substantially flat support region 106. Each of the plurality of leg assemblies 114 includes a pair of legs 116, 118 pivotally connected at a midpoint thereof by a pin 120. In a typical embodiment, the substantially flat support region 106 is operable to receive a load. The load shown in FIG. 1 is a conveyor assembly 122.

In a typical embodiment, the conveyor assembly 122 is operable to transport refractory material such as, for example, molded bricks, blocks, stone, tile, terrazzo or marble from a first end 124 of the conveyor assembly 122 which may be adjacent a refractory-material entry zone to a second end 126 of the conveyor assembly 122 which may be adjacent a refractory-material exit zone. In a typical embodiment, the refractory material is moved along a transport path 128 from the first end 124 to the second end 126 via, for example, a conveyor-belt assembly 130 and a chute 158. In a typical embodiment, the conveyor-belt assembly 130 includes a conveyor belt 131. In a typical embodiment, the conveyor belt 131 may be operated, for example, by a motor (not explicitly shown). The term “belt” as used herein is for illustrative purposes and includes a band, rope, chain, and the like. In a typical embodiment, the conveyor-belt assembly 130 includes an entry point, which entry point may be, for example, the first end 124 of the conveyor assembly 122. The conveyor-belt assembly 130 further includes an exit point 171 which may be adjacent an upper region of the chute 158.

The conveyor assembly 122 includes an electrical enclosure 132. In a typical embodiment, the electrical enclosure includes a cabinet or a case for accommodating a plurality of electrical switches, knobs, displays, and the like for operating the refractory delivery apparatus 100. In a typical embodiment, the electrical enclosure 132 is operable to accommodate a control panel. The control panel may include, for example, a conveyor-assembly activation switch 160, a conveyor-assembly direction switch 162, a power switch 164, an emergency-stop switch 166, and other circuitry for operating the conveyor assembly 122. In a typical embodiment, the conveyor-assembly activation switch 160 is operable to operate the conveyor assembly 122 in, for example, a manual operation mode or an automatic operation mode. Those having skill in the art will appreciate that the orientation and placement of the electrical enclosure 132 can be varied as design considerations dictate without departing from principles of the invention.

In a typical embodiment, the conveyor-assembly direction switch 162 is operable to control a direction of motion of the conveyor belt 131. The power switch 164 is operable to control the power supplied to the refractory delivery apparatus 100. The emergency-stop switch 166 is operable to terminate electrical power to the refractory delivery apparatus 100 in an emergency situation. The emergency-stop switch 166 may be activated under circumstances demanding an immediate cessation of operation of the refractory delivery apparatus 100.

The conveyor assembly 122 also includes a counter 134, which may be a digital counter. In a typical embodiment, the counter 134 may be connected, for example, to the electrical enclosure 132. In a typical embodiment, the counter 134 is operable to store and, in some instances, display a total quantity of the refractory material transported from the first end 124 to the second end 126. The conveyor assembly 122 also includes a plurality of angle guide brackets 136 and a plurality of conveyor mount brackets 138. In a typical embodiment, the plurality of angle guide brackets 136 are operable to guide the refractory material while the plurality of conveyor mount brackets 138 are operable to support and adjust the conveyor belt 131.

The conveyor assembly 122 also includes at least one electrical conduit 140 and at least one air-flow line 142. In a typical embodiment, the at least one electrical conduit 140 may be, for example, a metal or plastic pipe through which electrical wires are run for providing electrical power to various components of the conveyor assembly 122. In a typical embodiment, the at least one air-flow line 142 may be, for example, a metal or plastic pipe through which compressed air or another gas is supplied for operating a plurality of pneumatic air cylinders 148, 150. The conveyor assembly 122 also includes a plurality of limit switches 144, 146, a height-adjustment switch 147, a lift arm 152, a ram module 154 that may be covered by a ram-module guard 156, and the chute 158. The chute 158 may be, for example, a vertical plane, channel, or refractory material stacking passage through which refractory material is moved to the second end 126. In a typical embodiment, the second end 126 may be, for example, a chute exit point. The chute 158 is typically oriented substantially perpendicularly to the conveyor belt 131 of the conveyor-belt assembly 130 and is operable to receive the refractory material from the conveyor belt 131 for transport to the second end 126. In a typical embodiment, the plurality of air cylinders 148, 150, the lift arm 152, and the ram module 154 are operable to hold and transport the refractory material from the chute 158 to the second end 126.

In a typical embodiment, the first limit switch 144 is located at an upper region 170 of the chute 158. In a typical embodiment, the upper region 170 of the chute may be, for example, a chute entry point. In a typical embodiment, the first limit switch 144 may be, for example, a conveyor-belt-assembly limit switch 144. The second limit switch 146 is located near the second end 126 which end 126 may be, for example, the chute exit point. In a typical embodiment, the second limit switch 146 may be, for example, a chute limit switch 146.

In a typical embodiment, the conveyor-belt-assembly limit switch 144 and the chute limit switch 146 may be, for example, mechanical sensors requiring physical contact to detect presence or absence of an object. In a typical embodiment, the conveyor-belt-assembly limit switch 144 and the chute limit switch 146 are operable to cut off power automatically at or near a limit of travel of a moving object such as, for example, during the transport of the refractory material. In a typical embodiment, the conveyor-belt-assembly limit switch 144 is operable to control movement of the conveyor belt 131, thereby controlling the movement of the refractory material from the first end 124 to the second end 126. In a typical embodiment, the conveyor-belt-assembly limit switch 144 is operable to activate and deactivate the motor (not explicitly illustrated) powering the conveyor belt 131, thus allowing the conveyor belt 131 to run and stop at given intervals. In a typical embodiment, the chute limit switch 146 is operable to activate and deactivate the plurality of air cylinders 148, 150, the lift arm 152, and the ram module 154 which hold and transport the refractory material from the chute 158 to the chute exit point 126.

The height-adjustment switch 147 is operable to adjust an elevation of the lift 102. In a typical embodiment, the height-adjustment switch 147 is within the electrical enclosure 132; however, in other embodiments, the height-adjustment switch 147 may be present in other locations of the conveyor assembly 122.

While transporting the refractory material from the first end 124 to the second end 126, it is desirable to control the movement of the conveyor belt 131 in order to control flow and trajectory of the refractory material. It is also often desirable to adjust elevation of the first end 124 so that a first individual placing the refractory material on the conveyor belt 131 at the first end 124 does so at a comfortable (e.g., waist) level. It is also often desirable to adjust an elevation of the second end 126 such that a second individual receiving the refractory material at the second end 126 does so at a comfortable (e.g., waist) level. In a typical embodiment, the elevation of the first end 124 and the second end 126 is adjusted via the height-adjustment switch 147. Such an arrangement prevents individuals from having to work in stooped postures, thus minimizing back injuries.

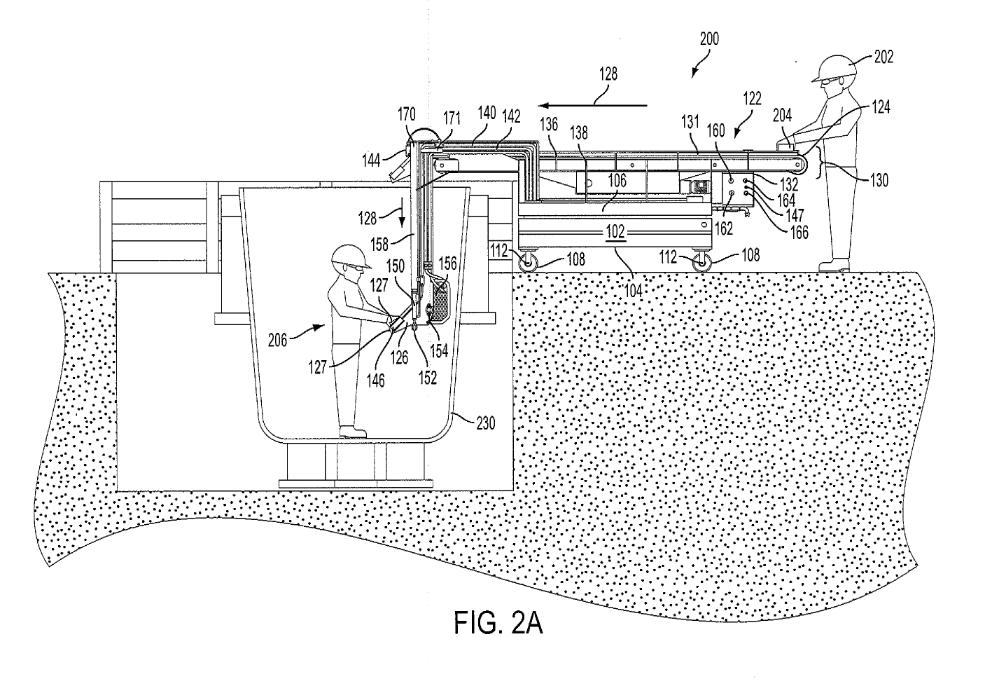

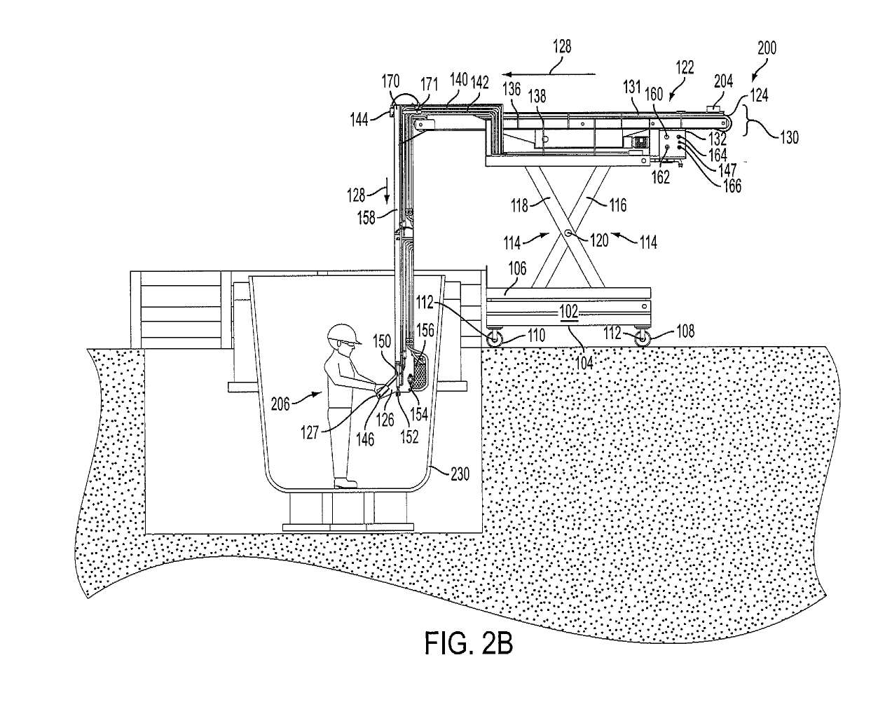

Referring now to FIG. 2A, a conceptual illustration of a refractory delivery apparatus 200 will be described in detail. In a typical embodiment, the conveyor assembly 122 is operable to transport refractory material 204 such as, for example, molded bricks, blocks, stone, tile, terrazzo or marble from the first end 124, which may be adjacent, for example, a refractory-material entry zone to the second end 126, which may be adjacent, for example, a refractory-material exit zone.

In a typical embodiment, the first end 124 and the second end 126 are at different elevations. For example, the second end 126 may be at a lower elevation than the first end 124. In other embodiments, the first end 124 and the second end 126 may be at the same elevation. The refractory material 204 is moved along the transport path 128 via the conveyor belt 131 and the chute 158. The conveyor belt 131 may be powered by a motor (not explicitly shown).

In operation, a first individual 202 operating the refractory delivery apparatus 200 adjusts an elevation of the lift 102 via the height-adjustment switch 147. In a typical embodiment, the elevation of the lift 102 is adjusted until the first end 124 and the second end 126 of the conveyor assembly 122 are at a comfortable (e.g., waist) level of the first individual 202 and a second individual 206, respectively. In the embodiment illustrated in FIG. 2A, the refractory material 204 is delivered into a vessel 230. The second individual 206, who is standing inside the vessel 230, is able to remove the refractory material 204 as the refractory material 204 reaches the second end 126. Such an arrangement prevents the individuals 202 and 206 from having to work in stooped postures, thus minimizing back injuries.

The refractory delivery apparatus 200 is further operable to control movement of the conveyor belt 131, thus controlling the rate at which the refractory material 204 is conveyed from the first end 124 to the second end 126. In a typical embodiment, the refractory material 204 is transferred from the conveyor belt 131 into the chute 158, where the refractory material is stacked. When the chute 158 is filled with the refractory material 204, a portion of the refractory material 204 located at a top of the stack contacts the first limit switch 144, which limit switch 144 is located at the upper region 170 of the chute 158. Upon contact by the refractory material 204, the first limit switch 144 deactivates the motor (not explicitly illustrated) powering the conveyor belt 131 in order to prevent any more of the refractory material 204 from entering the chute 158. In a typical embodiment, the first limit switch 144 controls the movement of the conveyor belt 131, thereby controlling the movement of the refractory material 204 from the first end 124 to the chute 158. In a typical embodiment, the first limit switch 144 may be, for example, the conveyor-belt-assembly limit switch 144.

Ones of the stacked refractory material 204 are individually lowered into a chamber within the chute 158 having the plurality of pneumatic air cylinders 148, 150, the lift arm 152, and the ram module 154. The plurality of pneumatic air cylinders 148, 150, the lift arm 152, and the ram module 154 are operable to hold and dispense ones of the refractory material 204 one at a time to the second end 126. In a typical embodiment, the second end 126 may be, for example, a chute exit point and may include, for example, a transfer tray 127. The transfer tray 127 may be oriented, for example, at a slight downward angle relative to another portion of the chute 158 so as to facilitate removal of the refractory material 204. Upon being transferred from the chute 158 to the second end 126, one or more of the refractory material 204 contacts the second limit switch 146 located near the second end 126. Upon contact by one or more of the refractory material 204, the second limit switch 146 deactivates the plurality of pneumatic air cylinders 148, 150, the lift arm 152, and the ram module 154, thus preventing more refractory material 204 from being transferred from the chute 158 to the second end 126. In a typical embodiment, the second limit switch 146 may be, for example, the chute limit switch 146.

Once the refractory material 204 that has contacted the second limit switch 146 is removed from the transfer tray 127 by the second individual 206, the second limit switch 146 activates the plurality of pneumatic air cylinders 148, 150, the lift arm 152, and the ram module 154, thus transferring another one of the refractory material 204 from the chute 158 to the second end 126. Upon transferring one of the refractory material 204 from the chute 158 to the second end 126, the refractory material 204 stacked in the chute region 158 moves downward, thereby causing the refractory material 204 contacting the first limit switch 144 to also move down into the chute 158 and lose contact with the first limit switch 144. Upon losing contact with the refractory material 204, the first limit switch 144 activates the motor (not explicitly illustrated) powering the conveyor belt 131 to move the refractory material 204 forward until another one of the refractory material 204 contacts the first limit switch 144. Such an arrangement of the first and second limit switches 144, 146 allows the second individual 206 to remove ones of the refractory material 204 one at a time. For example, each time one of the refractory material 204 is removed by the second individual 206, the next one of the refractory material 204 is transferred from the chute to the second end 126. In the embodiment illustrated in FIG. 2A, the refractory material 204 is delivered down into the vessel 230 so that the vessel 230 can be lined with the refractory material 204.

FIG. 2B is a conceptual illustration of the refractory delivery apparatus 200. The refractory delivery apparatus 200 as depicted in FIG. 2B is the same one disclosed earlier with respect to FIG. 2A; however, the conveyor assembly 122 is illustrated at a higher elevation than that illustrated in FIG. 2A. FIG. 2B thus illustrates that the elevation of the first and second ends 124, 126 of the refractory delivery apparatus 200 can be adjusted as required by individuals operating the refractory delivery apparatus 200.

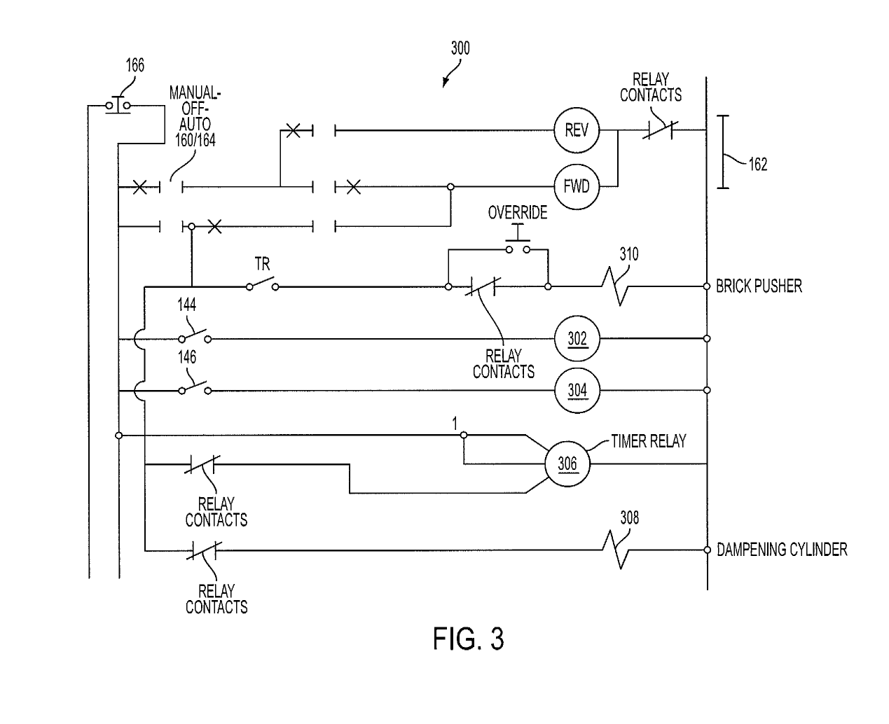

Referring now to FIG. 3, a control system 300 is illustrated. A schematic of the control system 300 illustrates circuitry for operating a conveyor-assembly activation switch 160, a conveyor-assembly direction switch 162, a power switch 164, an emergency-stop switch 166, and other circuitry for operating the conveyor assembly 122. In a typical embodiment, the conveyor-assembly activation switch 160 is operable to control the conveyor assembly 122 in, for example, a manual-operation mode and an automatic-operation mode. In a typical embodiment, the conveyor-assembly direction switch 162 is operable to control a direction of motion of the conveyor belt 131 of the conveyor assembly 122.

The power switch 164 is operable to control power supplied to the refractory delivery apparatus 100, 200. The emergency stop switch 166 is operable for terminating electrical power to the apparatus 100 in an emergency situation. The emergency stop switch 166 may be activated under circumstances demanding an immediate cessation of operation of the refractory delivery apparatus 100. The control system 300 also includes the limit switches 144, 146, a first control relay 302, a second control relay 304, a timer relay 306, a first solenoid valve 308, and a second solenoid valve 310.

In a typical embodiment, the first control relay 302, when energized, is operable to move the conveyor belt 131 in a forward direction. In a typical embodiment, the second control relay 304, when energized, is operable to initiate the timer relay 306 and activate the first solenoid valve 308. The first solenoid valve 308 controls operation of the pneumatic cylinder 150. In a typical embodiment, when the timer relay 306 is deactivated, the second solenoid valve 310 is activated. The second solenoid valve 310 controls operation of the pneumatic cylinder 148. The control system 300 as illustrated in FIG. 3 is illustrative. Other control circuitry can be employed without departing from principles of the invention.

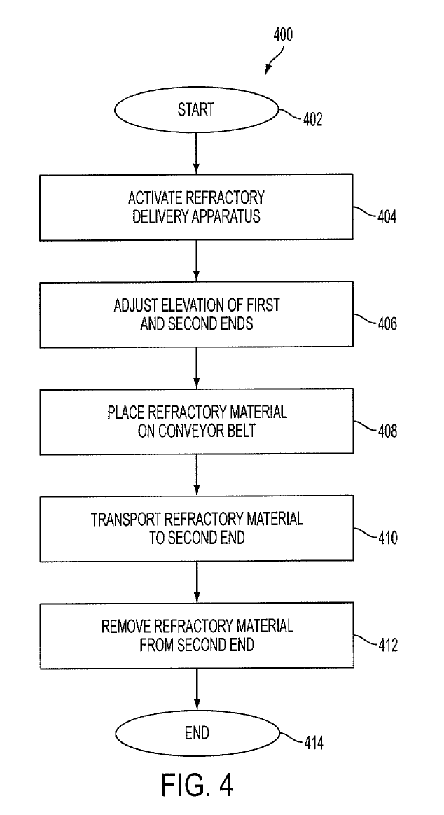

FIG. 4 is a flow diagram of a refractory-material transport process. For illustrative purposes, a process 400 will be described in conjunction with FIGS. 1-2B. The process 400 starts at step 402. At step 404, the first individual 202 activates the refractory-delivery apparatus 100, 200 by engaging the power switch 164 and the conveyor-assembly activation switch 160. At step 406, an elevation of the first and second ends 124, 126 is adjusted until the first and the second ends 124, 126 are at a comfortable (e.g., waist) level of the first and second individuals 202 and 206, respectively. In a typical embodiment, the elevation of the first end 124 and the second end 126 is adjusted via, for example, the height-adjustment switch 147. At step 408, the first individual 202 places the refractory material 204 on the conveyor belt 131. At step 410, the refractory material 204 is transferred via the chute 158 to the second end 126.

In a typical embodiment, the refractory delivery apparatus 100, 200 is operable to control movement of the conveyor belt 131, thus controlling the rate at which the refractory material 204 is conveyed from the first end 124 to the second end 126. In a typical embodiment, the refractory material 204 is transferred from the conveyor belt 131 into the chute 158, where the refractory material 204 is stacked. When the chute 158 is filled with the refractory material 204, a portion of the refractory material 204 located at a top of the stack contacts the first limit switch 144, which limit switch 144 is located at the upper region 170 of the chute 158. Upon contact by the refractory material 204, the first limit switch 144 deactivates the motor (not explicitly illustrated) powering the conveyor belt 131 in order to prevent any more of the refractory material 204 from entering the chute 158.

The stacked refractory materials 204 are individually lowered into a chamber having the plurality of pneumatic air cylinders 148, 150, the lift arm 152, and the ram module 154. The plurality of pneumatic air cylinders 148, 150, the lift arm 152, and the ram module 154 are operable to hold and dispense the refractory material 204 one at a time to the second end 126. In a typical embodiment, the second end 126 may include, for example, a transfer tray 127. The transfer tray 127 may be, for example, at a slight downward angle. Upon being transferred from the chute 158 to the second end 126, the refractory material 204 contacts the second limit switch 146 located near the second end 126. Upon contact by the refractory material 204, the second limit switch 146 deactivates the plurality of pneumatic air cylinders 148, 150, the lift arm 152, and the ram module 154, thus preventing more refractory material 204 from being transferred from the chute 158 to the second end 126.

Once the refractory material 204 that has contacted the second limit switch 146 is removed from the transfer tray 127 by the second individual 206, the second limit switch 146 activates the plurality of pneumatic air cylinders 148, 150, the lift arm 152, and the ram module 154, thus transferring another one of the refractory material 204 from the chute 158 to the second end 126. Upon transferring one of the refractory material 204 from the chute 158 to the second end 126, the refractory material 204 stacked in the chute region 158 moves downward, thereby causing the refractory material 204 contacting the first limit switch 144 to also move down into the chute 158 and lose contact with the first limit switch 144. Upon losing contact with the refractory material 204, the first limit switch 144 activates the motor (not explicitly illustrated) powering the conveyor belt 131 to move the refractory material 204 forward until another refractory material 204 contacts the first limit switch 144.

From step 410, the process 400 proceeds to step 412. At step 412, the second individual 206 removes the refractory material 204 from the second end 126. At step 414, the process 400 ends.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A material-delivery apparatus comprising:
a conveyor assembly operable to transport material;
a lift operable to change an elevation of the conveyor assembly;
wherein the conveyor assembly comprises:
a chute comprising a entry point and an exit point and having a limit switch associated with the chute exit point;
a conveyor-belt assembly comprising an entry point and an exit point and operable to transport the material from the conveyor-belt assembly entry point to the chute entry point and having a limit switch associated with the conveyor-belt assembly exit point;
wherein the conveyor-belt-assembly limit switch and the chute limit switch are operable in combination to control a rate at which the material is transported from the conveyor-belt-assembly entry point to the chute exit point.

2. The material-delivery apparatus of claim 1, wherein the lift comprises a substantially flat support region operable to support the conveyor-belt assembly.

3. The material-delivery apparatus of claim 1, wherein the chute comprises:
a transfer tray from which a user can remove a first unit of the material;
wherein, responsive to removal of the first unit, a second unit of the material is made to contact the chute limit switch;
wherein, responsive to contact by the second unit with the chute limit switch, the chute limit switch prevents additional units of the material from being dispensed into the transfer tray.

4. The material-delivery apparatus of claim 1, wherein the chute comprises a material-stacking passage.

5. The material-delivery apparatus of claim 1, wherein the chute is oriented substantially perpendicularly to a conveyor belt of the conveyor-belt assembly.

6. The material-delivery apparatus of claim 1, wherein the conveyor-belt-assembly limit switch is operable to stop operation of a conveyor belt of the conveyor-belt assembly responsive to a discrete unit of the material being in contact with the conveyor-belt-assembly limit switch.

7. The material-delivery apparatus of claim 6, wherein the conveyor-belt-assembly limit switch detects whether the chute has reached a maximal material-holding capacity.

8. The material-delivery apparatus of claim 3, wherein the transfer tray is angled relative to another portion of the chute so as to facilitate removal of the first unit of the material by the user.

9. The material-delivery apparatus of claim 1, wherein the elevation of the conveyor assembly is user adjustable.

10. The material-delivery apparatus of claim 1, wherein the elevation of the chute exit point is at a waist height of a user of the material-delivery apparatus.

11. The material-delivery apparatus of claim 1, wherein the material is a refractory material selected from the group consisting of molded brick, block, tile, terrazzo, marble, and combinations thereof.

12. A method of transporting material, the method comprising:
transporting, via a conveyor-belt assembly, the material from a conveyor-belt-assembly entry point to a chute entry point;
transporting, via a chute passage, the material from the chute entry point to a chute exit point; and
controlling, via a conveyor-belt-assembly limit switch and a chute limit switch, a rate at which the material is transported from the conveyor-belt-assembly entry point to the chute exit point.

13. The method of claim 12, further comprising adjusting, via a lift, an elevation of the chute exit point.

14. The method of claim 13, wherein the lift comprises a substantially flat support region operable to support the conveyor-belt assembly.

15. The method of claim 12, wherein the conveyor-belt-assembly limit switch is associated with an exit point of the conveyor-belt assembly.

16. The method of claim 12, wherein the chute limit switch is associated with the chute exit point.

17. The method of claim 16, wherein the chute exit point comprises a transfer tray from which a user can remove a first unit of the material.

18. The method of claim 17, wherein, responsive to removal of the first unit, a second unit of the material contacting the chute limit switch; and
wherein, responsive to the contacting step, the chute limit switch prevents additional units of the material from being dispensed into the transfer tray.

19. The method of claim 12, comprising deactivating operation of a conveyor belt of the conveyor-belt assembly responsive to a discrete unit of the material being in contact with the conveyor-belt-assembly limit switch.

20. The method of claim 19, wherein the controlling step comprises detecting, via the conveyor-belt-assembly limit switch, whether the chute passage has reached a maximal material-holding capacity.

21. The method of claim 12, wherein the material is a refractory material selected from the group consisting of molded brick, block, tile, terrazzo, marble, and combinations thereof.
